(19) United States
(12) Patent Application Publication
(10) Pub. No.: US 2008/0038505 A1
(43) Pub. Date: Feb. 14, 2008

(54) Three-dimensional cavity-formed part having a multilayered structure and process of its manufacture

(76) Inventor: Oliver Salzmann, Willich (DE)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/891,206

(22) Filed: Aug. 9, 2007

(30) Foreign Application Priority Data
Aug. 11, 2006 (DE) 10 2006 037 870.9
Sep. 6, 2006 (DE) 10 2006 041 714.3

(51) Int. Cl. B32B 1/06

(52) U.S. Cl. 428/71; 264/248

(57) ABSTRACT

The invention concerns a three-dimensional hollow molded piece having a multilayered construction, with a cavity formed by a substrate material and a cover material. The cavity is arranged between the substrate material and the cover material and filled with a filling medium. The hollow molded piece has in relation to the substrate material and the cover material a filmlike layer at least essentially impermeable to the filling medium, which is especially suitable for use in the furniture industry, especially for the manufacture of seating furniture.

### CROSS REFERENCES TO RELATED APPLICATIONS

This application claims priority to German Patent Application No. DE 10 2006 037 870.9, filed Aug. 11, 2006, and also claims priority to German Patent Application No. DE 10 2006 041 714.3, filed Sep. 6, 2006, entitled “THREE-DIMENSIONAL CAVITY-FORMED PART HAVING A MULTILAYERED STRUCTURE AND PROCESS OF ITS MANUFACTURE”. Both references are expressly incorporated by reference herein, in their entireties.

### BACKGROUND OF THE INVENTION

The present invention concerns a three-dimensional hollow molded piece according to the disclosure, as well as its use, especially for the production of furnishings, especially furniture, preferably seating furniture, decorative elements, hollow conduits, automotive accessories and the like, as well as the furnishings of the aforesaid kind made in this way. Finally, the present invention concerns a method for production of such a hollow molded piece.

In regard to the production of multilayered molded pieces, especially those containing a thermoplastic component or layer, the prior art specifies starting with a moldable sheetlike material, generally in the shape of a plate, and converting it by means of suitable methods into the desired three-dimensional form. In a subsequent step, the three-dimensional molded part so obtained can have another layer, such as a textile surface material or the like, placed on it or permanently fastened to it. Next comes securing of the textile surface material, e.g., by means of gluing or the like. To improve the properties of such materials, in particular, to enhance the ergonomics or anatomical contour in regard to the use of such molded pieces, such as for seating furniture, one can provide the molded pieces with cavities or additional deformable bodies.

However, in the prior art it is often not possible to introduce or arrange cavities, especially air-filled cavities that can contribute to improving the sitting comfort of seating furniture, between the particular layers of the molded piece, especially so that the cavities can also withstand load over rather long periods of time and be more or less airtight. Furthermore, it is difficult and costly in the prior art to outfit the molded piece with deformable bodies, such as gel cushions or foam plastic, inserted or arranged between the layers to afford a type of cushion effect and further enhance the sitting comfort. In this regard, it is necessary in the prior art to first produce said deformable bodies in a separate process—i.e., in addition to the production of the molded piece—which is cumbersome and cost-intensive, since numerous additional work steps and separate process equipment are required. Moreover, it is hard to integrate the separately produced deformable bodies in the molded piece, since properly positioning the deformable body inside the molded piece and joining it permanently to the molded piece is often unsuccessful.

Furthermore, the prior art does not always ensure that a deformable body already produced in a separate process and introduced into the molded piece will retain its original form during final production of the molded piece, e.g., when laminating a cover or sealing layer onto it, since additional stresses and forces can arise during heating of a textile surface material, that may permanently deform the deformable body.

Moreover, the fact that the textile surface material is applied to the substrate material only after forming of the sheetlike substrate and after outfitting the molded piece with the deformable bodies is disadvantageous since it makes gluing difficult; in particular, it is often not possible to connect the entire surface of the textile surface material to the formed material and the deformable body: in particular, in the region of intense forming, e.g., sharp bends, indentations or bulges or the like, there is an intensive stretching or compression of the textile surface material that can often lead to a detachment or delamination of the fabric. Furthermore, when a textile surface material is applied afterwards to the already formed material, which can have a deformable body in addition, an unwanted formation of wrinkles often occurs. A further drawback of this method is that a nonuniform tensile stressing of the textile surface material may result from the subsequent attachment of the textile surface material to the three-dimensional structure, which can lead to a nonuniform surface pattern and also an unwanted permanent deformation of the deformable body. Finally, the large and nonuniform restoring forces resulting from subsequent, sometimes nonuniform “shrinking” of the textile surface material on the substrate structure can lead to a subsequent deformation of the molded piece.

Given this technical background, the problem of the present invention is to provide a three-dimensional hollow molded piece as well as a method for its production which at least partly avoids or at the very least mitigates the above described disadvantages of the prior art. In particular, a three-dimensional hollow molded piece with a multilayered construction should be proposed having at least one cavity introduced or embedded in the layer structure and filled with a filling medium, which is not disturbed even under strong and forceful loading, especially compressive loads, and which also has good tightness with respect to the filling medium, even over long periods of time, and which leads to a significant improvement in sitting comfort, e.g., as compared to seating furniture. Furthermore, with regard to the hollow molded piece itself, it should be possible to realize sharp bends, indentations and bulges or the like without any delamination or wrinkling of the individual layers of the molded piece or a permanent deformation of the cavity filled with the filling medium. Finally, the resulting hollow molded piece itself should be self-supporting and highly stable in shape, so that it is suitable for use in particular in furniture, such as seating furniture.

To solve the above described range of problems, the present invention proposes a three-dimensional hollow molded piece according to the disclosure. Additional advantageous configurations are described hereinafter.

A further subject of the present invention is a method for production of the three-dimensional hollow molded piece according to the present invention.

Finally, the present invention deals with furnishings, especially furniture, preferably seating furniture, decorative elements, hollow conduits, and the like, which are made making use of the three-dimensional hollow molded piece according to the present invention.

Thus, a first subject of the present invention is a three-dimensional hollow molded piece having a multilayered construction and being especially suited for the making of furnishings, especially furniture, preferably seating furniture, decorative elements, hollow conduits, automotive accessories, and the like. The hollow molded piece according to the invention has at least one cavity formed by a substrate material and a cover material, wherein the cavity is arranged between the substrate material and the cover material and bounded by these materials and the cavity is filled with a filling medium. The invention provides for the substrate material and the cover material to be at least essentially impermeable to the filling medium, and for the substrate material and/or the cover material, preferably at least the cover material, to have a filmlike layer at least essentially impermeable to the filling medium.

As will be explained further below, both the substrate material and the cover material can have a multilayered structure, and it can be provided, in particular, that at least one of the materials, preferably the substrate material, be additionally outfitted with a substrate. In this way, especially shape-stable structures or forms can be realized that can also withstand a high-force loading. Furthermore, the substrate material or the cover material can be additionally provided with a textile surface material, preferably arranged on the side away from the cavity and thus more or less on the outside, so that the three-dimensional hollow molded piece of the invention is given a pleasing appearance or texture, and it is suitable in particular for use in the field of furniture manufacture.

The central idea of the present invention lies, in particular, in that the hollow molded piece is provided with a cavity which can be individually configured as to its shape, with the cavity being filled with a filler material that is preferably reversibly deformable. Thanks to the invention's concept of the cavity, it is preferably reversibly deformable, even and especially under load, and it has good impermeability to the introduced filler medium. In this way, the three-dimensional hollow molded piece of the invention can be used to make furniture in particular, such as seating furniture, having an anatomical adaptation to the user and an individual shaping while under high-force loading.

The aforesaid properties, and especially the good deformability and stability, especially in the sense of good tightness of the cavity filled with the filling medium, are assured by the filmlike layer provided at least for one material, i.e., for the substrate material or the cover material, preferably for both the substrate material and the cover material, which has both good flexibility, not diminishing or at least not substantially diminishing the reversible deformability of the cavity, and a blocking or barrier function with respect to the filler medium of the cavity. According to the invention, the filmlike layer(s) is or are more or less two-dimensionally integrated in the substrate material or the cover material. This makes it possible to realize the cavity or the filling of the cavity with the filler medium during the production of the three-dimensional hollow molded piece, which entails a deforming of the substrate material and/or the cover material. This constitutes a significant simplification of the process engineering, since in the context of the present invention it is not necessary to place any separate body into the hollow molded piece, such as a separately produced gel cushion or a foam plastic body.

The present invention is further characterized in that a stable composite material with layers permanently joined to each other over the full surface can already exist prior to the step or during the step of giving a shape to the substrate material and/or the cover material, and the impermeable filmlike layer can be an integral part of this composite material, i.e., of the substrate material and/or cover material. Thus, there is no need for subsequent application of layers or separate deformable bodies produced independently of the shaping process, since the cavity filled with the filling medium is encompassed and formed by integral layers of the molded piece, such as the filmlike layer(s), in particular. Thanks to this concept, according to the invention it is possible to configure cavities, with filler materials individually adapted to the particular usage purpose of the three-dimensional hollow molded piece according to the invention, already during the shaping to produce the hollow molded piece with concomitant permanent joining of the substrate material to the cover material. In this way, the cavity can be especially adapted to the desired requirement profile, for example, to provide an especially good anatomical adaptation. It is possible, in particular, to enable an exact positioning of the cavity within the hollow molded piece of the invention, e.g., in the seat or back region of a piece of seating furniture. In addition, subsequent “slipping” of the cavity is precluded.

Furthermore, it is possible to provide the hollow molded piece of the invention with regions formed to be especially strongly different from each other, without the applied textile surface material peeling off or wrinkling or the cavity becoming permanently deformed. In addition, because of the preferred use of a substrate which is hard and preferably not foamed and/or thermoplastic at the service temperature in the context of the present invention, these are shape-stable and self-supporting molded pieces that can withstand large loads, such as occur in particular when used in conjunction with seating furniture.

In the context of the present invention, by the term “three-dimensional” (three-dimensional hollow molded piece) is meant a structure having configured or spatial regions departing from the level or planar structure, including but not limited to indentations, bulges, depressions, bends, and the like.

Furthermore, according to the invention, the term “sheetlike” (e.g., sheetlike substrate material) refers to an at least essentially flat or planar form, while the thickness of the material is constant at least essentially over its surface. If desired for the application, however, the individual layers can also have different thicknesses relative to their surfaces, for example, in order to achieve a more optimized anatomical form for seating furniture.

By the term “cavity” (e.g., a cavity arranged between the substrate material and the cover material) is meant that the substrate material and the cover material of the invented three-dimensional hollow molded piece are arranged or joined or molded so that they at least essentially completely enclose the resulting cavity, while according to the invention it is preferable that the cavity be bounded or surrounded on all sides by the substrate material and the cover material so that a closed cavity results. According to the invention, the cavity is reversibly deformable or compressible thanks to the choice of the proper filler medium or by choice of the materials encompassing the cavity. According to the invention, the three-dimensional hollow molded piece can have a multitude or plurality of cavities, i.e., two, three, four or more cavities, for example, and the cavities can be joined together by channels, passageways, or the like. The term “cavity,” moreover, comprises a (hollow) space filled or partly filled with filler materials. The filling of the cavity with at least one filler material occurs preferably during the production of the three-dimensional hollow molded piece according to the invention in the context of the shaping of the substrate material and/or the cover material, and there can occur a pressurization during the production of the three-dimensional hollow molded piece, preferably with the filler, or a filling with filler materials, during or after the production of the three-dimensional hollow molded piece—as will be described in greater detail hereafter.

The term “associated” or “arranged” (e.g., a textile surface material associated with the impermeable filmlike layer or a fabric associated with the substrate) shall mean, according to the invention, that it is possible on the one hand for the textile surface material to be laminated directly or immediately onto the impermeable filmlike layer or the substrate, and on the other hand this term can likewise apply to an indirect association of the textile surface material in relation to the substrate layer, wherein, for example, at least one additional layer, such as a foam plastic layer, is arranged between the fabric and the substrate layer.

Furthermore, the term “shape-stable” (e.g., shape-stable substrate) according to the invention shall mean that the resulting three-dimensional hollow molded piece according to the invention can withstand or is able to absorb the loads resulting from the particular use, e.g., in the context of the production of seating furniture, wherein a reversible deformation is incorporated in this definition.

In the context of the present invention, the term “moldable” (e.g., moldable substrate) means the substrate or cover being molded under conservation of mass can be converted at least essentially irreversibly into another form or structure.

In this connection, the term “thermoformable” (e.g., thermoformable substrate) means, for example, that the substrate material used to make the three-dimensional hollow molded piece can be shaped by heating to a temperature region above the material softening point, especially by means of hot forming.

Finally, by the term “lamination” (e.g., lamination of the fabric onto another layer) is meant in particular a two-dimensional joining or gluing of the respective layers of the invented three-dimensional hollow molded piece, while the joining of the individual layers can be effected, for example, by means of methods well known to the practitioner, especially coating methods, generally by means of suitable lamination or film-coating means, such as adhesives, hot-melt glue, hot-melt glue webs and the like. In this connection, the two-dimensional joining or lamination or coating of the individual layers should preferably be over the entire surface, i.e., the coating means should preferably be applied continuously. At the same time, however, a dis-continuous joining is also possible by applying the adhesive in spots or a grid pattern. According to one special embodiment of the present invention, the respective layers of the invented three-dimensional hollow molded piece can be joined together by the flame lamination method, familiar to the practitioner, in which case it should be guaranteed that at least one layer has thermoadhesive properties.

Additional benefits, features, properties and aspects of the present invention will result from the following description of a preferred embodiment with reference to the figures.

### BRIEF SUMMARY

A three-dimensional hollow molded piece having a multilayered construction, with a cavity formed by a substrate material and a cover material. The cavity is arranged between the substrate material and the cover material and filled with a filling medium. The hollow molded piece has in relation to the substrate material and the cover material a filmlike layer at least essentially impermeable to the filling medium, which is especially suitable for use in the furniture industry, especially for the manufacture of seating furniture.

### BRIEF DESCRIPTION OF THE SEVERAL VIEWS OF THE DRAWINGS

FIG. 1 is a schematic cross section of the invented three-dimensional hollow molded piece according to one preferred embodiment.

FIG. 2 is a schematic representation of a piece of seating furniture according to the invention, made by using the invented three-dimensional hollow molded piece.

FIG. 3 is a schematic representation of the course of a process according to the invention for making the three-dimensional hollow molded piece according to the invention with the respective process steps (FIG. 3A to FIG. 3C).

### DETAILED DESCRIPTION

For the purposes of promoting an understanding of the disclosure, reference will now be made to the embodiments illustrated in the drawings and specific language will be used to describe the same. It will nevertheless be understood that no limitation of the scope of the disclosure is thereby intended, such alterations and further modifications in the illustrated device and its use, and such further applications of the principles of the disclosure as illustrated therein being contemplated as would normally occur to one skilled in the art to which the disclosure relates.

In the figures, the same reference numbers are used for the same or similar parts, and corresponding properties and advantages are achieved even if a repeated description is omitted for reasons of simplification.

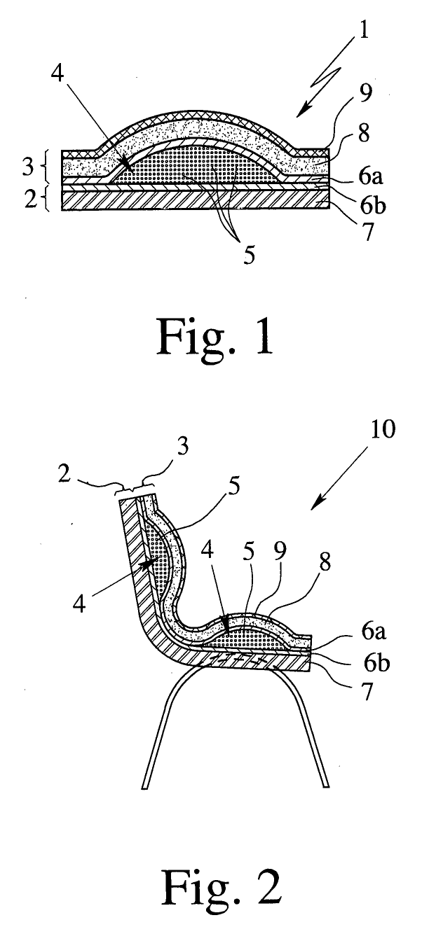

FIG. 1 shows an invented three-dimensional hollow molded piece 1 with multilayer construction, which is suitable in particular for the production of furnishings, especially furniture, preferably seating furniture, decorative elements, hollow conduits, automotive accessories and the like. According to the invention, the hollow molded piece 1 has at least one cavity 4 formed by a substrate material 2 and a cover material 3, while the cavity 4 is arranged between the substrate material 2 and the cover material 3 and bounded by these materials 2, 3. As FIG. 1 further shows, the cavity 4 is filled with a filler medium 5, and the substrate material 2 and the cover material 3 are at least basically impermeable to the filler medium 5. This is achieved, according to the invention, in that the substrate material 2 and/or the cover material 3, preferably at least the cover material 3, each has or have a filmlike layer 6a, 6b at least essentially impermeable to the filler medium 5. In other words, the invention provides that either the substrate material 2 or the cover material 3, or in an especially preferred embodiment of the invention both the substrate material 2 and the cover material 3, each has or have a filmlike layer 6a and 6b. It is preferred, according to the invention, that the filmlike layer 6a, 6b extend over the whole surface of the substrate material 2 and/or the cover material 3.

The present invention is characterized in that the substrate material 2 and the cover material 3 are permanently joined together or laminated together so that the three-dimensional hollow molded piece 1 of the invention results with at least one closed cavity 4, it being preferred according to the invention that the closed cavity 4 be bounded by the filmlike layer or layers 6a, 6b. In other words, according to one especially preferred embodiment of the invention, the filmlike layer 6a is joined at least in segments to the filmlike layer 6b or is laminated onto the layer 6b.

This can be achieved, for example, in that the substrate material 2 and the cover material 3 are joined together at their margin regions, for example, while it is equally possible according to the invention for the substrate material 2 and the cover material 3 to be joined together, especially in the manner of a web, in regions other than the margin regions, such as the central regions of the substrate material 2 and the cover material 3, so that several cavities 4 can be formed. According to the invention, the weblike connection in particular can likewise have interruptions or openings and/or channels, in order to make possible a connection of several cavities 4. The number of cavities 4 in regard to the invented three-dimensional hollow molded piece 1 is not limited. Thus, the invented three-dimensional hollow molded piece 1 can have two, three, four, five or more cavities 4.

As for the hollow molded piece 1 of the invention, the substrate material 2 and/or the cover material 3 can have curves, depressions, bulges, bends or the like. In other words, the substrate material 2 or the cover material 3 can have a three-dimensional form, so that in particular a three-dimensional form can also result in regard to the hollow molded piece 1 of the invention. Thanks to the high variability of the three-dimensional shaping, individual three-dimensional shapes or structures can be made so that a large number of different products results based on the three-dimensional hollow molded piece 1, especially in the context of the production of furniture, such as seating furniture. The hollow molded piece 1 of the invention is shape-stable in the sense of the aforesaid definition, however (as previously mentioned) a reversible deformation, especially of the cavity 4, is provided along with the deformation of at least one part of the adjoining layers.

The invented hollow molded piece 1 is particularly characterized in that the substrate material 2 and/or the cover material 3 can have a multilayer construction.

Thus, according to the invention, the substrate material 2 can have or consist of a substrate 7. The substrate 7 of the hollow molded piece 1 according to the invention is preferably configured to be nonporous or nonfoamed. Furthermore, according to the invention, the material for the substrate 7 can be a thermoplastic material, especially a thermoadhesive material, or the material for the substrate 7 can be a shape-stable material, especially a plastic, wood, metal, particularly aluminum. In other words, the substrate 7 according to one especially preferred embodiment of the invention is solid or, as such, free of voids.

In the context of the present invention, the material of the substrate 7 can be chosen from polymers or copolymers. In this regard, polyolefins, vinyl polymers, polyamides, polyesters, polycarbonates and polyurethanes are preferably considered. According to one preferred embodiment of the invention, the material of the substrate 7 comprises polyolefins, especially polyethylene or polypropylene, especially preferably polypropylene copolymerizates, or even acrylonitrile/butadiene/styrene (ABS) copolymerizates. For further details with regard to thermoplastics, one can refer to Römpp Chemistry Lexicon, 10^{th} ed., vol. 6, 1999, Georg Thieme Verlag, Stuttgart/New York, pages 4505/4506, key word: “thermoplastics,” and the entire content of that disclosure, including the bibliography mentioned there, is included here by reference.

Similarly, in the context of the present invention, one can also use so-called thermoplastic elastomers for the substrate 7, which have a combination of the usage properties of elastomers and the processing qualities of thermoplastics. For further details in this regard, one can likewise refer to Römpp Chemistry Lexicon, 10^{th} ed., vol. 6, 1999, Georg Thieme Verlag, Stuttgart/New York, pages 4506/4507, key word: “thermoplastic elastomers,” and the entire content of that disclosure, including the bibliography mentioned there, is included here by reference.

According to the invention, especially preferred for the optional substrate 7 are materials or thermoplastics having a yield stress per ISO 527 of 5-10 N/mm², preferably 10-45 N/mm², more preferably 15-40 N/mm², and especially preferably 20-35 N/mm². Similarly, the material of the substrate 7a or 7b should have an elongation at yield stress per ISO 527 of less than 20%, preferably less than 16%, more preferably less than 12%. Furthermore, the material of the substrate 7a or 7b should have a tensile strength at break per ISO 527 of at least 15 N/mm², preferably at least 20 N/mm², more preferably at least 25 N/mm², and/or an elongation at break per ISO 527 of 5-700% and a modulus of elasticity according to the four-point bending test per ISO 178 of 500-2200 N/mm², preferably 700-2100 N/mm², more preferably 900-1900 N/mm².

Furthermore, the material of the optional substrate 7 can be impact resistant without breaking at 23° C. (impact strength according to the Charpy test per EN ISO 179/1 eU) or have an impact strength according to the Charpy test per EN ISO 179/1 eU at −30° C. of at least 40 kJ/m², preferably at least 50 kJ/m², more preferably at least 60 kJ/m², especially preferably at least 70 kJ/m². Furthermore, the material of the substrate 7 can have a notch impact strength per EN ISO 179/1 eA at 23° C. of at least 15 kJ/m², preferably at least 25 kJ/m², more preferably at least 35 kJ/m². Moreover, the material of the substrate 7a or 7b can have a notch impact strength per EN ISO 179/1 eA at −30° C. of at least 1 kJ/m², preferably at least 2 kJ/m², more preferably at least 3 kJ/m², and furthermore have a ball indentation hardness (H358/30) per EN ISO 2039-1 of at least 50 N/mm², preferably at least 60 N/mm², more preferably at least 70 N/mm². Lastly, the material of the substrate 7 should have a density of 0.8-1.5 g/cm³, especially 0.85-1.4 g/cm³, more preferably 0.9-1.3 g/cm³. Finally, the material of the substrate 7 should have a Vicat softening temperature (VST A 120 or VST B 50) per ISO 306 of 80° C. to 200° C., preferably 85° C. to 180° C., more preferably 90° C. to 160° C.

Suitable materials for the substrate 7 are, for example, Metzo®Plast PP/C or Metzo®Plast ABS/M of Metzeler Plastics GmbH, Julich, Germany.

The thickness of the thermoplastic material or the substrate 7 can vary over broad ranges. According to the invention, the substrate 7 can favorably have a thickness of 1 mm to 20 mm, preferably 1.5 mm to 5 mm, more preferably 2 mm to 10 mm, especially preferably 2.5 mm to 7 mm, and most preferably 3 mm to 5 mm. But these values can be departed from according to the application or as an individual exception, for example, when the molded pieces 2a or 2b are intended to be used in the context of a structural unit 1 according to the invention, for example, to make furniture or seating furniture under special loading, in which case the thickness of the substrate 7 can then substantially exceed 15 mm.

As can be seen from FIG. 1, the substrate 7 is preferably part of a substrate layer 2, while according to the invention the substrate layer can likewise be formed by the substrate 7. In this case, the substrate 7 itself should preferably be at least essentially impermeable to the filler medium 5 of the cavity 4.

According to an especially preferred embodiment of the invention, the substrate material 2 has a 2-layer structure, shown as an example in FIG. 1, also having in addition to the substrate 7 the filmlike layer 6b, which is preferably placed on the side of the substrate 7 facing the cavity 4, or laminated thereon.

However, the present invention is not limited to such a 2-layer structure. Thus, according to the invention, the substrate material 2 can have additional layers, for example, an additional textile surface material in the sense of the definition below, placed or laminated on the side of the substrate 7 away from the cavity 4, which leads to further improved visual or textural qualities of the surface of the three-dimensional hollow molded piece 1 of the invention.

As is further seen from FIG. 1, the substrate material 2 and the cover material 3 each have a filmlike layer 6a, 6b, respectively, which more or less constitute the boundary or seal of the cavity 4, so that escape of the filler medium 5 located in the cavity 4 is in this way prevented.

As for the filmlike layer 6a, 6b itself, this can be chosen from polyurethanes, polyolefins, especially polyethylene or polypropylene, polyethers, polyesters, polyetheresters, polyimides and polytetrafluorethylene. The thickness of the filmlike layer 6a, 6b can vary over broad ranges. According to the invention, the filmlike layer 6a, 6b can have a thickness of 20 mm to 100 μm, preferably 10 mm to 200 μm, more preferably 5 mm to 50 μm. But these values can be departed from according to the application or as an individual exception.

Furthermore, it is preferable according to the invention for the filmlike layer 6a, 6b to be elastic, tear-resistant or flexible. Moreover, the filmlike layer 6a, 6b should be stretchable, preferably reversibly stretchable. In this regard, the filmlike layer 6a, 6b should have a stretching ability in at least one direction, preferably in the transverse and longitudinal direction, of at least 5%, especially at least 10%, more preferably at least 15%. Thanks to the aforesaid specific properties of the filmlike layer 6a, 6b it is in particular guaranteed that the cavity 4 containing the filler medium 5 can undergo a reversible shape change during a forceful loading or compression, for example, under a sitting load in the case of seating furniture, which leads to an especially good anatomical adaptation to the user.

As can be seen from FIG. 1, the filmlike layer 6a, 6b according to one especially preferred embodiment of the invention can be associated with the substrate material 2 and/or the cover material 3 so that the filmlike layer 6a, 6b faces the cavity 4. According to the invention, the filmlike layer 6a, 6b is permanently joined to the adjacent layers of the substrate material 2 or the cover material 3, for example, to the substrate 7 of the substrate material 2, by lamination, for example. Likewise, the permanent joining of the substrate material 2 on the one hand and the cover material 3 on the other can occur by a lamination of these materials 2, 3, as is shown in FIG. 1.

According to one especially preferred embodiment of the invention, the filmlike layer 6a, 6b is arranged on the substrate material 2 or the cover material 3 so that the filmlike layer 6a, 6b encompasses the cavity 4.

FIG. 1 shows an especially preferred embodiment of the invention, according to which both the substrate material 2 and the cover material 3 are provided with a filmlike layer 6a, 6b facing the cavity 4. The filmlike layer 6a, 6b can be laminated onto the layer associated with it, for example, on the substrate 7 in relation to the substrate material 2 or on a layer of foam material 8 or on a textile surface material 9 in relation to the cover material 3.

As can be further seen from FIG. 1, according to the embodiment with two filmlike layers 6a, 6b, these are joined together at marginal regions adjacent to the cavity 4, in particular, they are laminated, so that on the whole a multilayer material results with the substrate material 2 and the cover material 3, and the cavity 4 together with the surrounded filler material 5.

The present invention likewise comprises embodiments with only one filmlike layer (not shown), for example, a filmlike layer 6a associated with the cover material 3. Such an embodiment will be considered, in particular, when the substrate 7 of the substrate layer 2 itself has barrier properties, i.e., it is at least substantially impermeable to the filler material 5 of the cavity 4. In this case, the result is a multilayered structure which comprises the substrate material 2 and the cover material 3, as well as the cavity 4 filled with the filler medium 5, by a coordination or a lamination of the filmlike layer 6a with the substrate 7.

As mentioned previously, the substrate material 2 or the cover material 3 can comprise further layers. Thus, for example, an additional textile surface material can be associated with the substrate 7, especially on the side of the substrate 7 away from the cavity, so that appealing visual and textural qualities with regard to the multilayer structure also result on the side away from the cover material 3 (not shown).

As can further be seen in FIG. 1, according to the invention the cover material 3 can have a layer of foam material 8, preferably arranged on the side of the filmlike layer 6a away from the cavity 4. In this regard, the layer of foam material 8 can in particular be a foam material based on polyolefins or polyurethanes, preferably polyolefins. In this connection, it can be especially provided that the layer of foam material 8 be a closed-pore or closed-cell foam material. Such foam materials generally have less compressibility than open-pore foams, so that an optimal elastic and reversible compressibility under load exists when using the hollow molded piece 1 of the invention. Thus—when used in seating furniture—a compression of the foam material occurs under stress with a loading (“sitting down”), so that due to good adaptation to the user there results a pleasant and comfortable sitting feeling, especially also in the regions of the hollow molded piece where the layer of foam material 8 is not underlain by the cavity, while after the loading (“standing up”) the foam material is able to regain its original thickness.

As described above, the layer of foam material 8 is preferably associated with the filmlike layer 6a, while according to the invention a textile surface material can also be laminated on the side of the layer of foam material 8 away from the filmlike layer 6a. For this purpose, the layer of foam material 8 can be, in particular, a thermoplastic or especially a thermoplastically deformable foam material, preferably based on polyolefins or polyurethanes, with foam materials based on polyolefins being preferable according to the invention. Similarly, a polyethylene foam cross-linked by peroxide can be used according to the invention. Thanks to the special choice of the foam material, the textile surface material 9 is more or less supported so that the invented hollow molded piece 1 also has certain elastic and reversible compressibility or deformability under loading at the regions remote from the cavity 4. The foam material itself can likewise be plastically deformable, in particular, thermodeformable or thermoplastic, but the softening temperature should be chosen so that the foam material is not destroyed or too strongly compressed when molding the hollow molded piece of the invention for the purposes of a three-dimensional shaping. The foam material should at least be such that it can be given the desired three-dimensional shape due to its elasticity or deformability.

The layer of foam material 8 can have a thickness of 1 mm to 50 mm, especially 2 mm to 40 mm, preferably 3 mm to 30 mm, more preferably 4 mm to 25 mm, especially preferably 5 mm to 20 mm, and the thickness can vary within wide limits—depending on the desired area of application—and possibly depart from the indicated ranges.

As for the molded density of the layer of foam material 8, this can be 5-250 kg/m³, especially 10-150 kg/m³, preferably 20-100 kg/m³, more preferably 25-95 kg/m³.

As already explained, the layer of foam material 8 can be a layer of foam material or a layer made from a foamed material. The foam material used in this regard can have a tensile strength in the transverse and/or longitudinal direction per ISO 1926 of 100−1500 kPa, especially 150−1300 kPa, preferably 100−1100 kPa; in other words, the material for the foam layer 8 should have a tensile strength according to the cited standard in the longitudinal and/or transverse direction of at least 100 kPa, especially at least 150 kPa, preferably at least 200 kPa.

Furthermore, the material for the foam layer 8 should have an elongation at break in the longitudinal and/or transverse direction, per ISO 1926, of 50-350%, especially 65-225%, preferably 80-300%; in other words, the material for the foam layer 8 should thus have an elongation at break according to the cited standard in the longitudinal and/or transverse direction of at least 50%, especially at least 65%, preferably at least 80%. As for the compression hardness per ISO 844 of the material for the foam layer 8, this should be at least 5 kPa for a compression of 10%, especially at least 10 kPa, preferably at least 15 kPa; for a compression of 25%, it should be at least 25 kPa, especially at least 30 kPa, preferably at least 35 kPa; for a compression of 50%, it should be at least 85 kPa, especially at least 90 kPa, preferably at least 95 kPa. As for the compressive deformation resistance per ISO 1856/C, under a loading of 22 h and a compression of 25% at 23° C., the material of the foam layer 8 should have a compressive deformation resistance 0.5 h after release of the load of not more than 30%, especially not more than 25%, preferably not more than 20%, and 24 h after releasing the load it should have a value of not more than 20%, especially not more than 15%, preferably not more than 10%. Finally, the material for the foam layer 8 should have a μ-value per ISO 1663, at 0-85% relative humidity and 23° C., of 3000-20,000, especially 3500-19,000, preferably 4000-18,000.

According to the invention, the foam substances sold by Alveo AG of Lucerne, Switzerland, under the brand names Alveolit® and Alveolen® can be preferentially used for the layer of foam material 8 according to the invention.

Furthermore, FIG. 1 shows that the cover material 3 of the invented hollow molded piece 1 has a textile surface material 9 arranged preferably on the side of the filmlike layer 6a facing away from the cavity 4. In other words, the textile surface material 8 thus forms a type of surface for the hollow molded piece 1 of the invention.

In order to be able to realize the above-described strong shaping and bending of the invented hollow molded piece 1, the textile surface material 9 should generally be stretchable or flexible in order to effectively prevent a delamination or wrinkling. For this purpose, the textile surface material 9 can preferably be a woven, mesh, knit or laid-in fabric. According to one especially preferred embodiment of the invention, the textile surface material 9 is a woven fabric. Furthermore, however, it is equally possible for a leather or a synthetic leather to be used as the fabric 9. Likewise, filmlike plastics or thin-walled metal foils can also be considered as the fabric 9. In particular, the fabric 9 can be chosen such that it is at least essentially light-proof.

The weight per unit area of the textile surface material 9 can vary within broad limits. Thus, the textile surface material 9 can have a weight per unit area of 25-600 g/m², especially 50-500 g/m², preferably 100-400 g/m². For the mentioned purposes, in order to avoid a premature delamination or wrinkling and in order to produce strong bending or shaping with regard to the invented hollow molded piece 1, the textile surface material 9 should be reversibly-stretchable and/or especially bielastic, i.e., stretchable or highly elastic in both directions. The textile surface material 9 can have an extensibility in at least one direction, preferably in the longitudinal and transverse direction, of at least 5%, especially at least 10%, preferably at least 20%.

According to one especially preferred embodiment of the invention, an especially bielastic woven textile cloth is used as the textile surface material 9, for example having an elasticity in the warp direction of about 35% or more and in the weft direction an elasticity of 20% or more.

According to one especially preferred embodiment, one can use a bielastic woven cloth, having a weight per unit area of 350 g/m² with an elasticity in the warp direction of 35% and an elasticity in the weft direction of 20%. Such a woven cloth can contain, for example, around 4.8% Elastan®, around 89.3% polyester and around 5.9% polyamide, in terms of the overall weight of the fabric. It is likewise possible, according to the invention, for the textile surface material 9 to be additionally impregnated, coated, or the like, in order to make the fabric 9 flame-retardant, for example, or to improve the stain resistance.

According to the invention, the textile surface material 9 can be laminated by means of a lamination and/or film coating agent, especially an adhesive, onto the layer associated with the textile surface material 9, for example, the layer of foam material or the filmlike layer 6a or, within regard to the substrate material 2, onto the substrate 7.

As for the cavity 4 enclosed in particular by the filmlike layer 6a, 6b, according to the invention this is partly or at least basically entirely filled with a filler medium 5, as shown in FIGS. 1 and 2. In this connection, the filler material 5 can be chosen from the group of gases, especially air or nitrogen, liquids, gels, especially low-viscosity, medium-viscosity or high-viscosity gels, and solid substances, such as foams and foam plastics, especially polystyrene, polyurethane or polyolefin foam plastics. The material used to fill the cavity 4 can likewise be a multicomponent foam plastic. In this regard, besides the above-mentioned closed-pore foam plastics, open-pore ones can also be considered. Filling of the cavity 4 with the filler material 5 can occur, for example, during the manufacture of the invented hollow molded piece—as will be explained hereafter in the context of the method of the invention—with the filler material 5 being introduced between the substrate material 2 and the cover material 3, for example, through channels or openings, or through the gap produced by the separation of the substrate material 2 from the cover material 3 provided in the context of the making of the invented hollow molded piece 1, into the cavity 4 during the formation of same, or the latter can be formed by pressure application when the filler medium 5 is being introduced.

As for the filler materials 5 in solid form which can be used in the invention, such as the aforementioned foam substances, these can be introduced, for example, into the cavity 4 in liquid, non-cross-linked form, with a cross-linking or hardening, possibly including a foaming, occurring in the cavity 4 itself. For this, multicomponent foams can be considered, for example. However, it is equally possible to introduce the solid filler materials 5 into the cavity 4 in comminuted form, for example, in the form of foam beads. Generally, the filler materials used should be reversibly deformable or reversibly compressible, and the elasticity of the materials used will bring about an optimized anatomical adaptation to the user of a seat, for example, so that there is a better adaptation to the shape of the body when the three-dimensional hollow molded piece 1 of the invention is used as seating furniture with a seat and/or back piece, as shown in FIG. 2.

Furthermore, the filler material 5 used should be chosen so that, when the force applied to the invented hollow molded piece 1 is relieved (for example, by “standing up”), it is able to at least basically regain its original shape or structure.

Furthermore, with regard to the hollow molded piece 1 of the invention, the respective layers 6b, 7 of the substrate material 2 and/or the respective layers 6a, 8, 9 of the cover material 3 can be joined to each other or laminated one onto the other, especially by means of a laminating agent or thanks to the natural adhesiveness, especially the hot adhesiveness of at least part of the respective layers 6b, 7 and/or the respective layers 6a, 8, 9.

Furthermore, according to the invention, the substrate material 2 and the cover material 3 can be joined together so that the cavity 4 is entirely enclosed by the substrate material 2 and cover material 3, so that in this way a kind of closed-off or fully sealed cavity 4 results from which the filler material 5 can no longer emerge.

With regard to the finished hollow molded piece 1 of the invention, the cover material 3 can be laminated onto the substrate material 2 except for the region of the cavity 4. In this case, therefore, the layers of the substrate material 2 and of the cover material 3 that are associated with the cavity 4 are connected to each other. If—according to an especially preferred embodiment of the invention—the hollow molded piece 1 of the invention has two filmlike layers 6a, 6b, the invention specifies that the cavity 4 is surrounded by the filmlike layer 6a of the cover layer 3 and the filmlike layer 6b of the substrate layer 2, so that in this preferred case the filmlike layer 6a is laminated to the filmlike layer 6b at the corresponding contact sites.

According to one preferred embodiment of the invention—as shown in FIGS. 1 and 2—the substrate material 2 of the invented hollow molded piece 1 has a filmlike layer 6b encompassing the cavity 4 and at least essentially nonpermeable to the filler medium 5, especially as defined above, and a substrate 7 arranged on the side of the filmlike layer 6b facing away from the cavity 4, especially as defined above. Furthermore, the cover material 3 according to this especially preferred embodiment of the invention comprises a filmlike layer 6a encompassing the cavity 4 and at least essentially impermeable to the filler medium 5, especially as defined above, and a layer of foam material 8 arranged on the side of the filmlike layer 6b facing away from the cavity 4, especially as defined above, and a textile surface material 9 arranged on the side of the layer of foam material 8 facing away from the filmlike layer 6a, especially as defined above.

With regard to dimensioning of the layers, the respective layers 6b, 7 and 6a, 8, 9 can have identical dimensions in terms of area, so that the layers are arranged more or less congruently relative to the hollow molded piece 1 of the invention.

According to a special embodiment, not shown in the figures, the cavity 4 can have a preferably closable opening, especially a valve, for filling (replenishing) the cavity 4 with filler medium 5 as needed and/or for venting filler medium 5 from the cavity as needed. In this way, for example, when using the hollow molded piece 1 as seating furniture, the volume or the “hardness/softness” of the cavity 4 and accordingly the sitting comfort can be controlled specifically and efficiently, as required.

The present invention is characterized in that a hollow molded piece according to the invention is prepared such that it already has all layers, so that no subsequent layers need to be put on. Thanks to the special choice of the aforesaid layers, strongly or especially pronounced three-dimensional structures can be realized in terms of the hollow molded piece 1, so that the three-dimensional hollow molded piece 1 according to the invention is suitable for a large number of applications, since an individual adaptation is possible. Furthermore, the specific use of the filmlike layers 6a, 6b enables the invention to ensure that the cavity 4 with the filler medium 5 contained therein is at least essentially entirely sealed off, so that a closed cavity 4 results from which the filler material 5 can not escape, even under heavy loading. Furthermore, a high stability of the invented hollow molded piece is achieved thanks to the lamination of the particular layers, so that no delamination occurs even under strong loading.

As for the hollow molded piece 1 of the invention, its final form is more or less suitable for the respective application purpose and therefore it can be used immediately for furnishings, such as furniture (e.g., seats), decorative elements, hollow conduits and the like, for example, as a molded element of the bottom or back side of a seat piece or back piece or as a complete shell for a chair. For this, the hollow molded piece according to the invention can be additionally outfitted with static elements (e.g., rests, supports, connection elements, rods, chair feet, etc.), as is shown for example in FIG. 2. In this regard, support or fixation points for the mentioned elements can be introduced into the invented hollow molded piece 1, such as by means of boreholes.

Furthermore, the present invention—according to another of its aspects—concerns the use of the invented three-dimensional hollow molded piece 1, especially as defined above, for the making of furnishings, such as furniture, especially seats, decorative elements like partition walls and the like, hollow conduits and the like, automotive accessories and the like. Especially preferably, the invented hollow molded piece can be used for seating furniture and the like, where the term “seating furniture” is to be taken very broadly and includes sitting facilities or sitting elements of every kind, such as, but not limited to, benches, chairs, stools, sofas, three-piece couches, armchairs and the like. The seating furniture can have the form of a hollow molded piece according to the invention or at least contain such a piece. Basically, the furnishings can be used for purposes of interior decoration as well as for purposes of exterior decoration.

According to the invention, the hollow molded piece can form certain units or elements of the seating furniture, such as a one-piece seat/back part (seat shell). Alternatively, two different hollow molded pieces according to the invention can be used for a seat part and a back part. In this regard, the cover material can form more or less the side facing the user, while the substrate material represents the back side of the three-dimensional hollow molded piece of the invention used as a seat/back piece. Thus, there is a specific and goal-oriented differentiated combination of ergonomic properties and stability properties (front side comfortable, back side firm). According to the invention, the term “front side” means the side of the seating furniture facing the user of the seating furniture, while the term “back side” means the side facing away from the user in the state of use of the seating furniture.

Furthermore, the three-dimensional hollow molded piece of the invention can also be used for saddles and the like, especially since the invented hollow molded piece can have strong bending and shaped regions, so that an exact fitting of the saddle made from the invention to the user's anatomy is possible, and in this case the cavity filled with filler material will have an especially important role. After all, the cavity enables an especially good adaptation to the anatomy of the user. Another area of application of the invented hollow molded piece is, for example, its use for seating furniture in public transit facilities, since the above-described specific layered structure with full-surface lamination achieves a high stain resistance, since stains cannot penetrate deeply into the material, and on the other hand the secure gluing of the individual layers results in a high protective function against destruction, such as by vandalism.

Additionally, the invented hollow molded piece can be used as a decorative element or in the form of hollow conduits, such as cable enclosures or covers.

According to another aspect of the present invention, the present invention likewise concerns furnishings, such as furniture, decorative elements, hollow conduits and the like and preferably seating furniture, which have at least one invented hollow molded piece or consist of the same. Thanks to the specific construction of the invented hollow molded piece, this can take on both bearing, supporting and mechanical functions, as well as surface-forming, visual qualities in relation to the furnishings, especially furniture such as seating furniture. The invented furnishings, especially furniture such as seating furniture, have significantly fewer individual components than in the prior art, and they in turn can be fabricated with fewer work steps and less tooling expenditure.

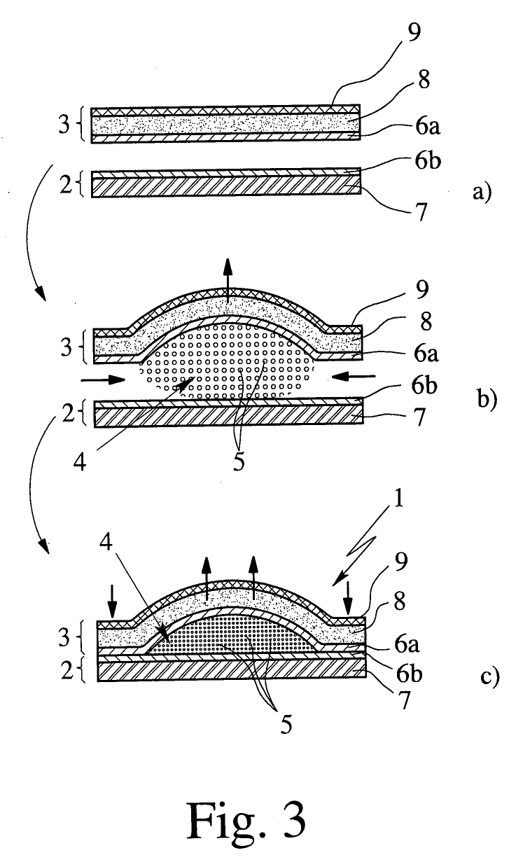

Finally, another object of the present invention—according to another aspect thereof—is a method, illustrated by FIG. 3, for the making of a three-dimensional hollow molded piece 1, especially as defined above, wherein at least one intermediate space bounded by a substrate material 2 and a cover material 3 is filled by introducing a filler medium 5, possibly under deformation of the substrate material 2 and/or the cover material 3, and the substrate material 2 and the cover material 3 are sealingly joined together so that at least one closed cavity 4 results that is encompassed by the substrate material 2 and the cover material 3 and is filled with the filler medium 5.

Thus, the method of the invention can be carried out, for example, in such a way that first of all—as depicted in FIG. 3A—a two-dimensional or sheetlike substrate material 2 and a cover material 3 are prepared, each of them comprising several layers of the aforesaid kind, such as a substrate 7 and a filmlike layer 6b in relation to the substrate material 2, and a filmlike layer 6a, a layer of foam material 8, and a textile cover layer 9 in relation to the cover material 3. According to the invention, one can proceed in such a way that the respective layers of the substrate material 2 and of the cover material 3 are already laminated before the shaping and the bringing together of the respective materials 2, 3 and the formation of the cavity 4 and the filler medium 5. Likewise, one can proceed also to laminate the respective layers of the substrate material 2 or the cover material 3 during the shaping of the substrate material 2 or the cover material 3 with concomitant formation of the cavity or its filling with the filler medium 5.

FIG. 3 schematically illustrates the course of the individual process steps of the method of the invention: FIG. 3A shows the sheetlike starting materials used, namely, the substrate material 2 and the cover material 3, which more or less act as starting material for the making of the invention's three-dimensional hollow molded piece 1. The substrate material has a two-layer construction with a substrate 7 and a filmlike layer 6b associated with it, while the cover material 3 has a three-layer construction, comprising a filmlike layer 6a, a layer of foam material 8 placed on the filmlike layer 6a, and a textile backing material 9 placed on the layer of foam material 8. Additionally, however—as already explained—other layer constructions differing from this embodiment are also possible.

A major benefit of the invented method is that—as illustrated by FIG. 3B—two especially thermoplastic sheetlike starting materials are deformed in three dimensions, more or less in a single work step at the same time, while forming or filling a cavity 4 with a filler medium 5, and these are joined together in such a way that the hollow molded piece 1 of the invention is obtained with the closed and filled cavity 4.

FIG. 3B shows the deformation of the cover material 3, which can occur, for example, in that the materials 2, 3, initially at a slight distance from each other, are placed in a mold consisting of two partial molds, it being possible for the partial molds to be configured as positive and negative molds. By heating the substrate material 2 and the cover material 3—which can generally be done before bringing the materials 2, 3 into the mold, but also during the placement into the mold—the materials 2, 3 are heated to a temperature above the softening point of the layer of foam material 8 and/or the substrate 7 and/or the layers 6a, 6b. A deforming of the substrate material 2 and/or the cover material 3 can be achieved, for example, by applying pressure between the partial molds, but also by applying a partial vacuum between the partial molds and the respective materials, whereupon the substrate material 2 and the cover material 3 become attached to the respective partial mold and are deformed. According to the invention, either the substrate material 2 or the cover material 3 or both the substrate material 2 and the cover material 3 can be deformed in this manner. During this step—as further shown schematically in FIG. 3B—the cavity 4 arising between the materials 2, 3 can be filled with a filler medium 5 of the previously defined type or the cavity 4 can be formed by pressurized introduction of the filler medium 5. FIG. 3C shows the final three-dimensional hollow molded piece 1 of the invention, where the materials 2, 3, namely the substrate material 2 and the cover material 3, are pressed together, for example by bringing the partial molds together, so that the substrate material 2 is joined to the cover material 3 and in particular the filmlike layer 6b and the filmlike layer 6a are joined together, especially in segments, resulting in the closing of the cavity 4. The bringing together of the materials 2, 3 can take place at the same time as the forming of the cavity 4. After cooling down, the invented hollow molded piece 1 can be removed from the mold or molds.

In the context of the manufacture of the invented hollow molded piece 1, the twin-sheet method known to the practitioner can be used, and the practitioner will be able at any time to adapt the corresponding process parameters in light of the present invention. For further information as to the method of the invention, one can refer to the remarks concerning the hollow molded piece of the invention, which apply here accordingly. Other configurations, modifications and variations of the present invention will be easily understood and implemented by the practitioner from a reading of the specification, without thereby departing from the scope of the present invention.

While the preferred embodiment of the invention has been illustrated and described in the drawings and foregoing description, the same is to be considered as illustrative and not restrictive in character, it being understood that all changes and modifications that come within the spirit of the invention are desired to be protected.

1. A three-dimensional hollow molded piece having a multilayered construction, especially for the making of furniture, decorative elements, hollow conduits, automotive accessories, and the like;
wherein the hollow molded piece has at least one cavity formed by a substrate material and a cover material; and
wherein the cavity is arranged between the substrate material and the cover material and encompassed these materials and the cavity is filled with a filling medium, and wherein the substrate material and the cover material are at least essentially nonpermeable to the filling medium, and the substrate material and/or the cover material have a filmlike layer at least essentially impermeable to the filling medium.

2. The hollow molded piece according to claim 1, wherein at least the cover material has a filmlike layer at least essentially impermeable to the filling medium.

3. The hollow molded piece according to claim 1, wherein the substrate material and the cover material have a filmlike layer at least essentially impermeable to the filling medium.

4. The hollow molded piece according to claim 1, wherein the substrate material and/or the cover material have curvatures, depressions, bulges, bends or the like.

5. The hollow molded piece according to claim 1, wherein the substrate material and/or the cover material have a multilayered structure.

6. The hollow molded piece according to claim 1, wherein the substrate material has or consists of a substrate.

7. The hollow molded piece according to claim 6, wherein the substrate is nonporous and not foamed.

8. The hollow molded piece according to claim 6, wherein the material for the substrate is a thermoplastic, heat-adhesive, form-stable material.

9. The hollow molded piece according to claim 1, wherein the material of the filmlike layer(s) is chosen from the polyurethanes, polyolefins, polyethers, polyesters, polyetheresters, polyimides and polytetrafluorethylenes.

10. The hollow molded piece according to claim 1, wherein the filmlike layer(s) have a thickness of 20 mm to 100 μm.

11. The hollow molded piece according to claim 1, wherein the filmlike layer(s) is or are each designed to be elastic, tear-resistant, and flexible, and wherein the filmlike layer(s) is or are designed to be stretchable.

12. The hollow molded piece according to claim 1, wherein the filmlike layer(s) is or are arranged on the substrate material and/or on the cover material so that the filmlike layer(s) is or are facing the cavity.

13. The hollow molded piece according to claim 1, wherein the cover material has a layer of foam material arranged on the side of the filmlike layer facing away from the cavity.

14. The hollow molded piece according to claim 1, wherein the cover material has a textile surface material arranged on the side of the filmlike layer facing away from the cavity.

15. The hollow molded piece according to claim 1, wherein the filler material is chosen from the group of gases, gels, foams and foam materials.

16. The hollow molded piece according to claim 1, wherein the substrate material and the cover material are joined to each other so that the cavity is fully enclosed by the substrate material and cover material.

17. The hollow molded piece according to claim 1, wherein the cavity is enclosed by the filmlike layer of the cover layer and the filmlike layer of the substrate layer.

18. The hollow molded piece according to claim 1, wherein the cavity has a closable opening for introducing or releasing filler medium, as needed.

19. The hollow molded piece according to claim 1, wherein the substrate material has a filmlike layer basically impermeable to the filler medium and encompassing the cavity and a substrate arranged on the side of the filmlike layer facing away from the cavity, and wherein the cover material has a filmlike layer basically impermeable to the filler medium and encompassing the cavity and a layer of foam material arranged on the side of the filmlike layer facing away from the cavity.

20. The hollow molded piece according to claim 19, wherein the cover material furthermore comprises a textile surface material arranged on the side of the layer of foam material facing away from the filmlike layer.

21. A method for making a three-dimensional hollow molded piece according to claim 1, wherein at least one intermediate space bounded by a substrate material and a cover material is filled by bringing in a filler medium while shaping the substrate material and/or the cover material, and the substrate material and the cover material are sealingly joined together so that at least one closed cavity results that is filled with the filler medium and encompassed by the substrate material and the cover material.

22. An object, chosen from the group of furnishings, furniture, seating furniture, decorative elements, hollow conduits, and automotive accessories, wherein the object has at least one three-dimensional hollow molded piece according to claim 1.
